(19) United States
(12) Patent Application Publication
(10) Pub. No.: US 2007/0195068 A1
(43) Pub. Date: Aug. 23, 2007

(54) Pen apparatus and method of assembly

(75) Inventors: Robert G. Kable, Dublin, OH (US); Adam T. Kable, Powell, OH (US); Lawrence J. Heringer, Sunbury, OH (US); Brent G. Wilson, Plain City, OH (US)

Correspondence Address: MUELLER AND SMITH, LPA;MUELLER-SMITH BUILDING, 7700 RIVERS EDGE DRIVE, COLUMBUS, OH, 43235, US

(73) Assignee: Scriptel Corporation

(21) Appl. No.: 11/360,220

(22) Filed: Feb. 23, 2006

(51) Int. Cl. G09G 5/00; B43K 25/00; G06F 3/033

(52) U.S. Cl. 345/179

(57) ABSTRACT

Pen apparatus and method of assembly wherein a pick-up rod assembly performs in conjunction with a normally closed switch to define a pen-up tip switch condition. Coordinate signal information is provided from the pick-up rod assembly to a signal treatment network carried by an elongate printed circuit board which supplies a bias and electrical communication to the pick-up rod assembly through an electrically conductive helical spring. That spring also provides switch closure bias and tip switch information is transferred from the switch to a pen orientation detector network at the circuit board through a stamped metal transition component. Bias generated at the signal treatment network is further utilized in providing tip switch information to the pen orientation detector network.

### CROSS-REFERENCE TO RELATED APPLICATIONS

### STATEMENT REGARDING FEDERALLY SPONSORED RESEARCH

Not applicable.

### BACKGROUND OF THE INVENTION

The history of technical development of electrographic devices is relatively short. At the present time, the operational quality of the now ubiquitous products is such that the terms “pen”, “paper” and “ink” are used in describing these computer driven interactive systems. Price and product reliability now have become significant factors in the electrographic market, the earlier significant challenges in technical development having been met.

Early approaches to digitizer structures looked to an arrangement wherein a grid formed of two spaced arrays of mutually, orthogonally disposed fine wires was embedded in an insulative carrier. One surface of this structure served to yieldably receive a stylus input, which yielding caused the grid components to intersect and readout coordinate signals. Later approaches to achieving readouts were accomplished through resort to a capacitive coupling of what was then termed a “stylus” or “locating instrument” with the position responsive surface to generate paired analog coordinate signals. Capacitive couplings was carried out either with a grid layer which is formed of spaced linear arrays of conductors or through resort to the use of an electrically resistive material layer or coating.

In the early 1980s, investigators recognized the promise of combining a digitizer surface with a visual readout. This called for a digitizer surface which was provided as a continuous resistive coating which was transparent. A variety of technical problems were encountered in the development of an effective resistive coating type digitizer technology, one of which was concerned with the non-uniform nature of the coordinate readouts received from the surface. Generally, precise one-to-one correspondence or linearity between the position of a stylus and the resultant coordinate signals was necessitated but posed an illusive goal. Because the resistive coatings could not be practically developed without local thickness variations, the non-linear aspects of the otherwise promising approach called for a substantial amount of research and development. A quite early investigation in this regard is described by Turner, in U.S. Pat. No. 3,699,439 entitled “Electrical Probe-Position Responsive Apparatus and Method”, issued Oct. 17, 1972. This approach used a direct current form of input to the resistive surface from a hand-held stylus, the tip of which was physically applied to the resistive surface. Schlosser, et al., in U.S. Pat. No. 4,456,787, entitled “Electrographic System and Method”, issued Jun. 26, 1984, described the development of an a.c. input signal in conjunction with such devices as well as the signal treatment of the resulting coordinate pair output. This transparent system applied excitation signal to a passive tablet. See additionally in this regard, Quayle, et al., U.S. Pat. No. 4,523,654. A voltage waveform zero-crossing approach was suggested by Turner to improve resolution in U.S. Pat. No. 4,055,726 entitled “Electrical Position Resulting by Zero-Crossing Delay”, issued Oct. 25, 1977. Kable, in U.S. Pat. No. 4,600,807 issued Jul. 15, 1986, described a signal treatment technique for transparent digitizer systems. In general, this approach utilized a plurality of switches along the four coordinate borders of the tablet structure. An a.c. drive signal was applied from one border, while the opposite border was retained at ground for a given coordinate readout, for example, in the x-axis direction. Plus and minus values were developed for generating x-coordinate pairs as well as y-coordinate pairs. During the evaluation process those switches aligned along the borders not being used as ground or as drivers were retained in a “floating” condition. Thus, the switching exhibited three states for a given coordinate generating operation. Such utilization of a third or floating state with the switches was the subject of some noise generation and the investigators looked to avoidance of the floating state as well as the relatively large requisite number of switches which were required.

Substantially improved accuracies for the resistive surface-type digitizing devices was achieved through a critically important correction procedure developed by Nakamura and Kable as described in U.S. Pat. No. 4,650,926, issued Mar. 17, 1987. With the correction procedure, memory retained correction data was employed with the digitizer such that any given pair of coordinate signals were corrected in accordance with data collected with respect to each digitizer resistor surface unit during its manufacturer. With such an arrangement the speed of correction was made practical and the accuracy of the devices was significantly improved. In general, this correction procedure remains in the industry at the present time.

In order to avoid interference from externally generated noise, hand effect and the like, investigators determined that resistivities for transparent digitizers preferably should have fallen within predetermined acceptable ranges, for example, between 400 and 3,000 ohms per square. To achieve higher levels of resistivities as desired, very thin resistive coatings, for example, indium tin oxide (ITO) were employed. However, it was observed that over a period of time, surface effects would effect the resitivity value of a given tablet occasioning an unwanted “drift” of such value as to effect long term accuracy. To improve the long term stability of the coatings, thicker coatings have been employed in combination with discontinuities in the layer itself as was described by Kable, et al. in U.S. Pat. No. 4,665,283, issued May 12, 1987. Improvements in performance also were achieved through utilization of angular-shaped electrodes at corner positions as well as a conductive band or band of enhanced conductivity which was positioned intermediate the outer periphery of the digitizer device and the active area thereof as described by Nakamura and Kable, in U.S. Pat. No. 4,649,232, entitled “Electrographic Apparatus”, issued Mar. 10, 1987.

Improvements in the pick-up devices utilized with digitizers were evolved to enhance overall performance of the systems. For example, an improved tracer or cursor is described by Kable, et al., in U.S. Pat. No. 4,707,572, entitled “Tracer for Electrographic Surfaces”, issued Nov. 17, 1987. Similarly, Kable described an improved stylus (now pen) structure in U.S. Pat. No. 4,695,680, entitled “Stylus for Position Responsive Apparatus Having Electrographic Application”, issued Sep. 22, 1987. In 1988, Schlosser and Kable developed a transparent electrographic system and apparatus which achieved very important aspects of distortion control without undue loss of operational surface. This development lowered the number of solid-state switching components required about the border of the active surface and the three state approach was eliminated. The development permitted a broad range of practical applications of the resultant technology not only for utilization with digitizer tablets but also for such applications as electronic notepads and the like. That technology continues in production at the present time 14 years later, notwithstanding Moore's Law (Gordon Moore, Fairchild Semiconductor Corporation, 1964). See Schlosser and Kable, U.S. Pat. No. 4,853,493, issued Aug. 1, 1989.

### BRIEF SUMMARY OF THE INVENTION

The present invention is addressed to pen apparatus for use with electrographic surfaces and a method of making it. Designed to incorporate a minimum number of parts which are assembled with minimized procedural steps, the apparatus enjoys a high level of reliability and is fabricable at improved cost levels.

Tip switching to provide pen-up and pen-down orientation data to an associated computerized processing system is carried out with a switching function axially aligned with the axis of the pen and which is configured having a normally closed orientation corresponding with a pen-up condition. Actuated to an open switch condition by a very small pen-down axial movement of a pick-up rod assembly, the mechanical operation of the switch is essentially non-detectible by an operator. Switching contact action is made highly reliable through the utilization of an electrically conductive conformal surface at a moveable contact member. In this regard, the surface is developed with a carbon-filled silicon insert. Voltage bias is applied to the pick-up rod assembly from a signal treatment network carried by an elongate printed circuit board assembly. Engagement from that circuit board with the pick-up rod assembly is through a pen axis aligned electrically conductive helical spring which further provides a mechanical switch closing bias to the switching function. Transmission of tip switch conditions back to a pen orientation detection network supported at the printed circuit board is through a resilient, stamped and thus inexpensive metal transition contact member which, during pen assembly is simply inserted within a cartridge enclosure component without a soldering or connection requirement.

That pen orientation distribution network uniquely employs a bias voltage developed by the signal treatment network to generate pen-up or pen-down orientation information. To provide pen compatibility with the many fold electrographic systems in the field, the pen orientation detector network incorporates a delay function which is activated following an operator writing maneuver from a pen-up to a pen-down operation. Such a delay negates polluted, z-axis related coordinate data.

The method for making this pen apparatus comprises the steps:
(a) providing a generally cylindrical polymeric outer housing extending, along a pen axis, from a tip region having a mouth, to a cable support region;
(b) providing a pair of generally half cylindrical polymeric cartridge enclosure components which when abuttably mated to define a cartridge enclosure are slideably insertable within the outer housing in symmetrical disposition about the pen axis. That cartridge enclosure defines a forward region with a containment cavity, an intermediate region and a rearward cable engagement region;
(c) providing an elongate circuit board having oppositely disposed surfaces designated upper surface and lower surface extending between a forward end and a rearward end, the upper surface supporting a signal treatment network having an input junction at the forward end locatable at the pen axis and an output extending to a terminal array adjacent the rearward end, the upper surface further supporting a pen orientation network having an input at an electrical contact pad generally adjacent the forward end at the lower surface locatable at the pen axis and having an output extending to the terminal array;
(d) providing a pick-up rod assembly extending from a tip to a collar assembly with a rearward connector portion and forwardly disposed switch contact portion locatable at the cartridge enclosure containment cavity;
(e) providing a cable assembly with an array of leads corresponding with the terminal array;
(f) electrically coupling the cable assembly array of leads with the circuit board terminal array;
(g) providing an electrically conductive helical spring;
(h) coupling the helical spring to the circuit board supported signal treatment network input junction at the forward end in a manner wherein the spring extends forwardly for general alignability with the pen axis to a forward connection portion;
(i) coupling the pick-up rod assembly rearward connector portion to the spring forward connection portion in a manner wherein the pick-up rod assembly extends forwardly for general alignability with the pen axis, the pick-up rod assembly, spring, circuit board and cable assembly defining a sub-assembly generally locatable symmetrically about the pen axis;
(j) providing a transition contact member with a contact portion and an integrally formed resilient extension;
(k) inserting the transition contact member within one cartridge enclosure component in a manner wherein the contact portion is locatable within the containment cavity and the resilient extension extends rearwardly;
(l) inserting the sub-assembly upon one cartridge enclosure component;
(m) positioning the other cartridge component over the one cartridge component to define a cartridge enclosure;
(n) providing a generally cylindrical electrostatic shield assembly having a sleeve portion and a forwardly extensible necked-down portion;
(o) inserting the cartridge enclosure within the shield assembly sleeve portion;
(p) providing a polymeric pen tip;
(q) inserting the pen tip over the shield assembly necked-down portion in a manner internally engaging the pick-up assembly tip to define a pen interior;
(r) testing the pen interior; and
(s) when the pen interior passes the testing step, then inserting the pen interior into the outer housing.

Other objects of the invention will, in part, be obvious and will, in part, appear hereinafter.

The invention, accordingly, comprises the apparatus and method possessing the construction, combination of elements, arrangement of parts and steps which are exemplified in the following detailed disclosure.

For a fuller understanding of the nature and objects of the invention, reference should be had to the following detailed description taken in connection with the accompanying drawings.

### BRIEF DESCRIPTION OF THE DRAWINGS

FIG. 1 is a schematic representation of a one-dimensional model of an electrographic apparatus of the type employing the pen apparatus of the invention;

FIG. 2 is a schematic equivalent circuit of the model of FIG. 1;

FIG. 3 is a schematic idealized curve showing voltage distribution across the resistant layer represented in FIG. 1;

FIG. 4 is a top view of an electrographic tablet which may be employed with the pen apparatus of the invention;

FIG. 5 is a side view of pen apparatus according to the invention illustrating its contact with a glass support surface of an electrographic tablet;

FIG. 6 is a sectional view taken through the plane 6-6 shown in FIG. 5;

FIG. 6A is an enlarged partial view of a region of the pen apparatus shown in FIG. 6:

FIG. 6B is a view similar to FIG. 6A but showing a switch function in an open condition;

FIG. 6C is a partial view of the switch function shown in FIGS. 6A and 6B;

FIG. 6D is a perspective view of a transition contact member employed with the pen apparatus of the invention;

FIG. 7 is an exploded view of the pen apparatus of the invention;

FIG. 8 is a top view of a printed circuit board employed with the pen apparatus of the invention;

FIG. 9 is a bottom view of the printed circuit board of FIG. 8;

FIG. 10 is an electrical schematic representation of a signal treatment network and a pen orientation detector network according to the invention;

FIG. 11 is a schematic curve and timeline showing pen-up and pen-down functions;

FIG. 12 is a schematic view illustrating capacitive coupling of the pen apparatus of the invention corresponding with the timeline of FIG. 11;

FIGS. 13A and 13B combine as labeled thereon to show a process for assembling the pen apparatus of the invention;

FIG. 14 is an exploded view showing portions of the fabrication process described in connection with FIGS. 13A and 13B; and

FIG. 15 is a top view of a cartridge enclosure component with a transition contact number having been located therein as described in connection with FIG. 13A.

### DETAILED DESCRIPTION OF THE INVENTION

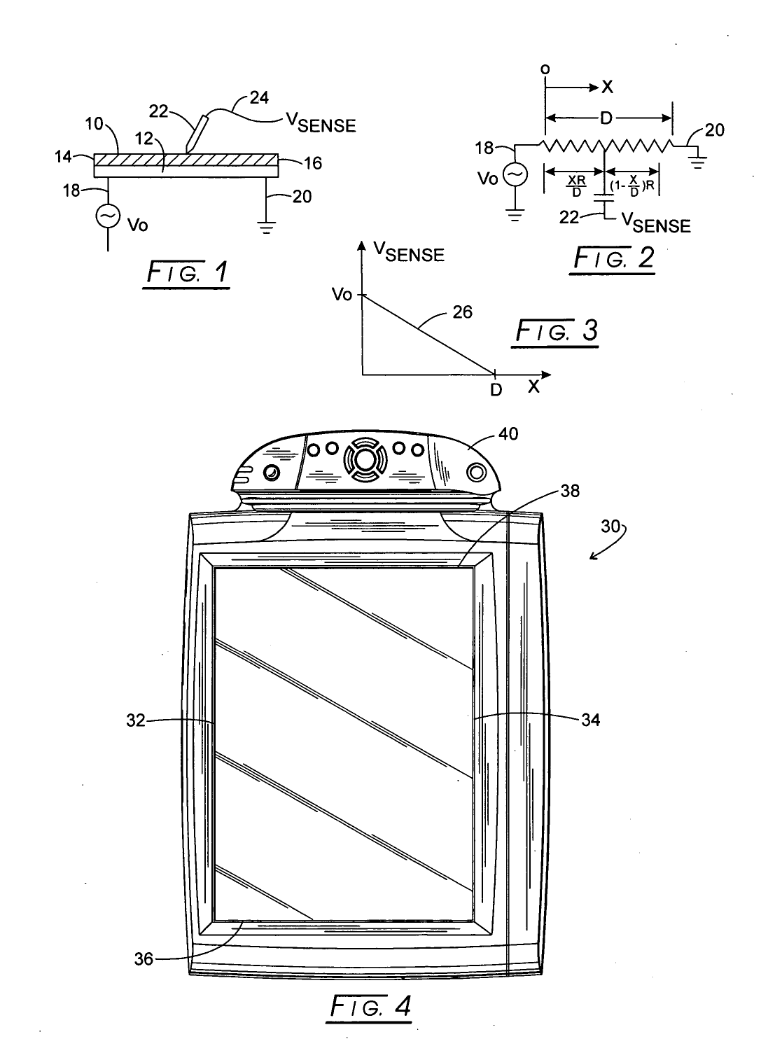

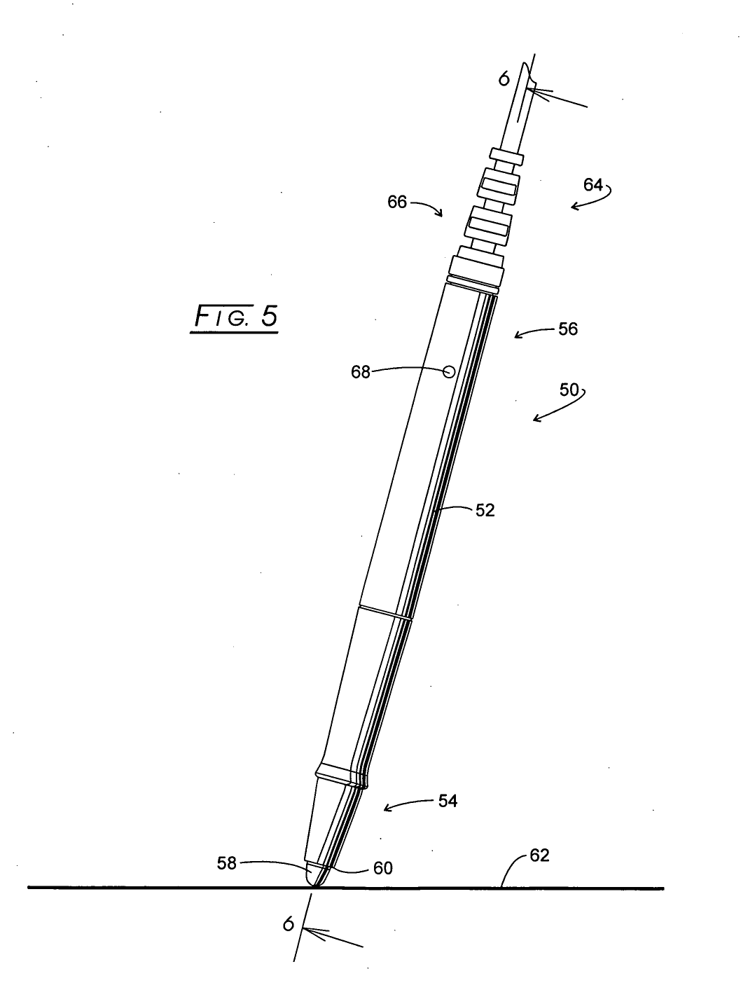

As a preliminary consideration of the general approach taken with resistant surface electrographic technology, reference is made to FIGS. 1 and 2 wherein an idealized one-dimensional model is revealed. In FIG. 1, an insulative support 10 such as glass is shown overlaying and supporting a resistive layer of, for example, indium-tin oxide 12. Electrodes 14 and 16 are shown coupled to the resistive layer 12 at the opposite ends or borders thereof. Electrode 14 is coupled with an a.c. source designated V₀ from line 18, while electrode 16 is coupled to ground through line 20. A pen 22 is positioned in contact with the glass support 10 which, through capacitive coupling serves to pick-up a voltage output at line 24, such voltage being labeled Vₛₑₙₛₑ. The equivalent circuit for this idealized one-dimensional model is represented in FIG. 2 where the resistive layer 12 is shown as a resistor and the distance of the pen 22 from the edge of the resistor closest to the source V₀ is represented as “X”. “D” represents the distance between electrodes 14 and 16. That fraction of resistance of layer 12 which extends from the source of voltage excitation to the location, X, may be represented as XR/D, while the distance from the location of the pen 22 to the opposite electrode as at 16 or line 20 may be represented as the labeled value (1−X/D)R. The corresponding idealized value for Vₛₑₙₛₑ is shown in FIG. 3 as being linear as represented at the curve 26. As a result of a variety of phenomena, such linearity becomes an approximation, however, achieving adequate linearity prior to the application of necessary electronic treatment has been seen to be highly desirable.

To derive signals representing coordinate pairs with respect to the position of the pen 22 on the resistive surface 12, measurements of the voltage Vₛₑₙₛₑ are made along orthogonally disposed axes designated x and y. Through the utilization of switching, the application of the voltage source as through line 18 and connection of ground as through line 20 as shown in FIG. 1 are alternately reversed for each of the x and y coordinates. With the values thus obtained, for each designated x and y coordinate, a difference/sum voltage ratio is determined to obtain a coordinate position signal.

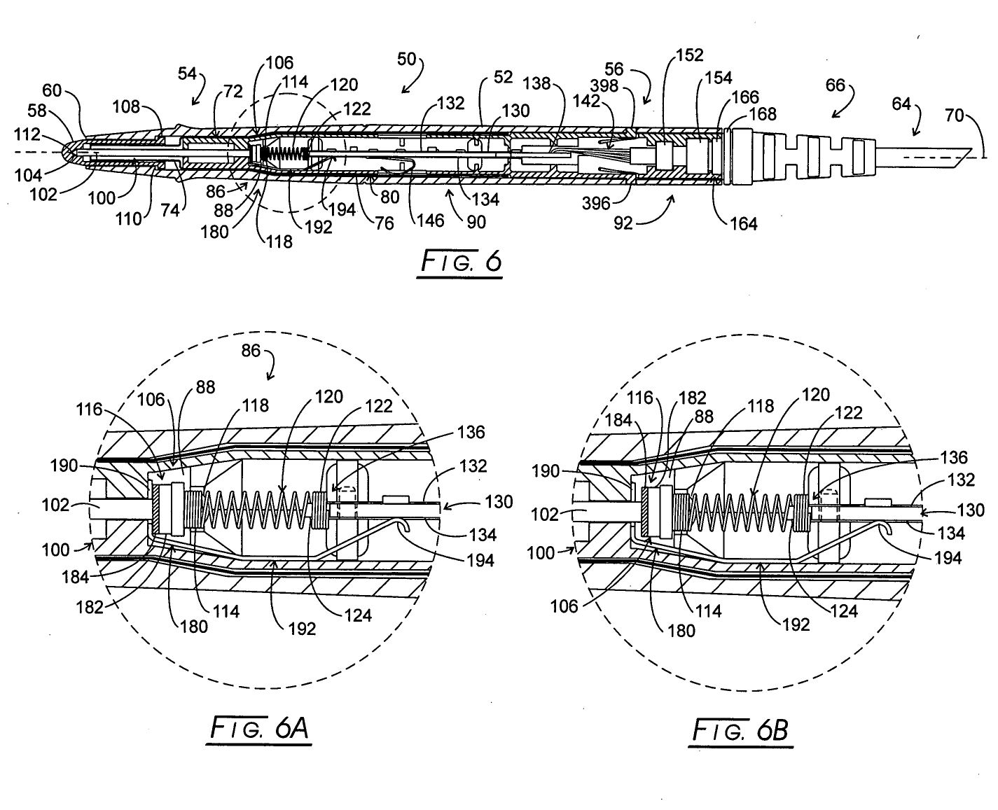

Looking to FIG. 4, a digitizer tablet with which the pen apparatus of the invention may perform is represented generally at 30. Tablets as at 30 may be developed having a broad variety of overall shapes and sizes from small and compact to relatively large. The devices generally are structured as a patterned layer of indium-tin oxide (ITO) which is deposited over a transparent glass support. The borders of the glass which support an x-coordinate orientation may be observed at 32 and 34, while the borders of the glass for the y-coordinate consideration are seen at 36 and 38. The resistive layer supported on glass is transparent but is deposited in pattern such that the deposit itself is thick enough to avoid resistivity drift due to surface effects while maintaining desired resistivity characteristics. Techniques for achieving this stability are described in the above-noted U.S. Pat. No. 4,665,283. In general, for smaller tablets having overall boundary sizes of about 12 inches by 12 inches, for example, a generally desirable value of resistivity of 600 ohms per square is employed along with an excitation, for example, at 120 KHz. For larger tablets, the resistivity preferably is altered to 900 ohms per square. However, for typical applications of digitizer tablets, it is desirable to maintain the resistivity under 1,000 ohms per square to avoid hand effects and the like. Also seen in FIG. 4 is the polymeric housing 40 which retains the circuitry employed in operation of the tablet. Not shown in the figure is pen connecting cable assembly. The ITO layer pattern and the tablet drive is described in the above-noted U.S. Pat. No. 4,853,493 which is incorporated herein by reference. In accordance with the teachings of that patent, only four corners are primarily assessed by the circuitry of the device with a utilization of corner positioned L-shaped electrodes.

Looking in more detail to the sum/difference ratio procedure employed with tablets as at 30, the output of the pen 22 may be termed XPLUS when an alternating current force is applied along the x+ coordinate direction from appropriate adjacent corners of tablet 30 while simultaneously, ground supplied to the opposite, x− corners. Arbitrarily designating XMINUS to be the signal at pen 22 when the opposite condition obtains wherein the alternating current force is applied to the x− coordinate adjacent corners of the resistive layer and ground is applied to the oppositely disposed, x+ edge; designating YPLUS to be the signal at pen 22 when the alternating signal source is applied to the adjacent corners of the resistant layer at the y+ coordinate and ground is applied to the opposite or y− coordinate adjacent corners; and designating YMINUS to be the signal derived at pen 22 when the alternating current source is effectively applied along the adjacent corners of the resistive layer at the y− coordinate position thereof, while ground is applied at the adjacent corners of tablet 30 represented at the y+ side. With the arrangement, coordinate pair signals may be derived and signal values may be employed with a difference/sum ratio to derive paired coordinate signals for any position on the active surface of the tablet as follows:

$$position x = \frac{( XPLUS ) - ( XMINUS )}{( XPLUS + ( XMINUS}$$

$$position y = \frac{( XPLUS ) - ( YMINUS )}{( YPLUS ) + ( YMINUS )}$$

Looking to FIG. 5, a pen for collecting position signals from an electrographic surface in accordance with the invention is represented generally at 50. Pen 50 is illustrated with a generally cylindrical outer housing 52 which extends along the pen axis represented by the 6-6 section line from a tip region represented generally at 54 to a cable support region represented generally at 56. At the tip region 54 a polymeric and dielectric pen tip 58 is seen extending from the mouth 60 of outer housing 52. Pen tip 58 is illustrated in contact with the surface of a glass support 62 of an electrographic tablet.

Rearward cable support region 56 is seen supporting a cable assembly represented generally at 64 which is configured having integrally molded stress relief nodules represented generally at 66. The cable will be seen to support an array of four input/output leads. Also seen in the figure is a detent or dog receiving hole 68. An identically positioned hole is located symmetrically opposite that of 68.

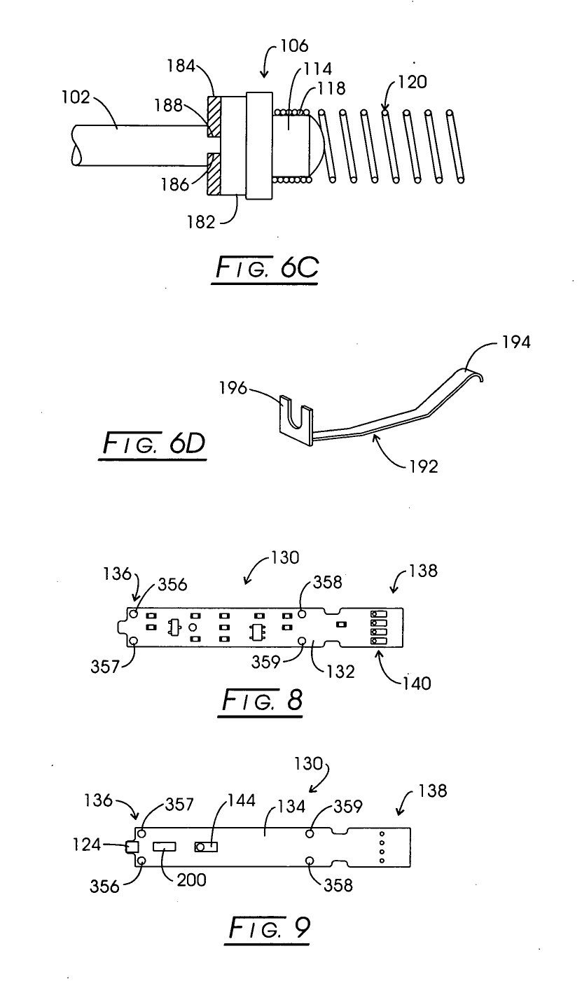

Referring to FIG. 6, pen 50 appears in sectional view disposed about pen axis 70. Within the outer housing 52 there is slideably located a brass electrostatic shield represented generally at 72. As seen additionally in FIG. 7, shield 72 is configured with a necked-down portion 74 which is integrally formed with and extends forwardly from a sleeve portion 76. Slideably inserted within the shield sleeve portion 76 is a generally cylindrical polymeric cartridge enclosure represented generally at 80. As seen in FIG. 7, cartridge enclosure 80 is configured with a pair of identically structured generally half cylindrical cartridge enclosure components represented generally at 82 and 84. When abuttably joined together components 82 and 84 define a forward region represented generally at 86 having a containment cavity 88; an intermediate region represented generally at 90; and a cable engagement region represented generally at 92.

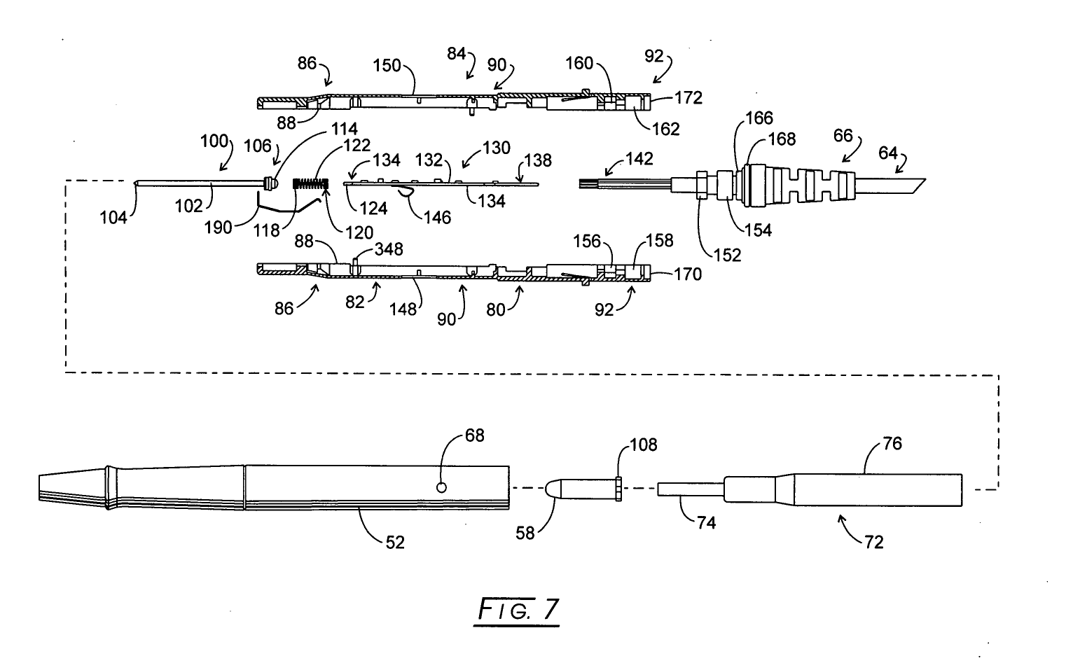

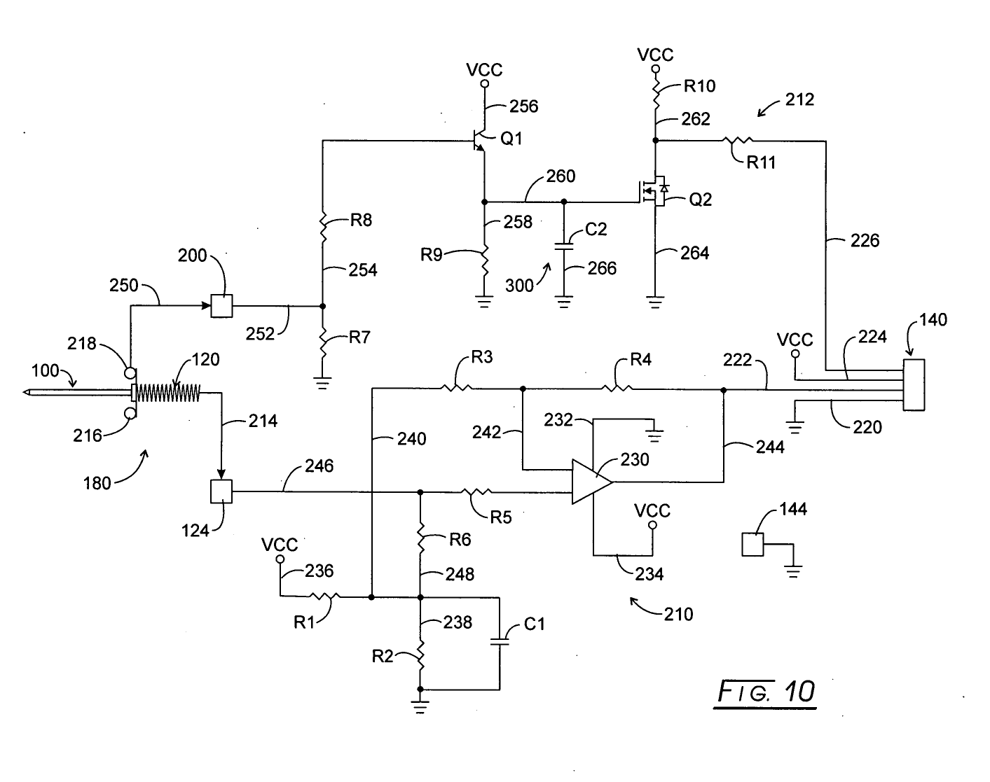

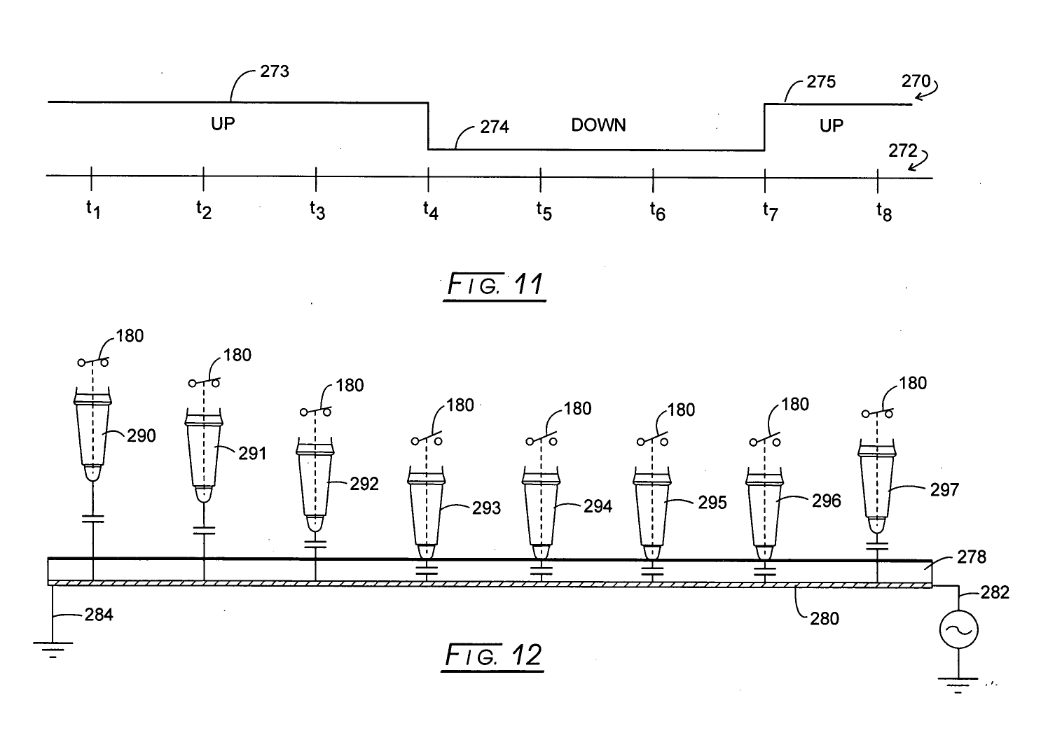

Slideably extending through the forward region 86 of cartridge enclosure 80 and through the necked-down portion 74 of electrostatic shield 72 is a pick-up rod assembly represented generally at 100. Assembly 100 is configured with a rod-shaped portion 102 which, as seen in FIGS. 6 and 7, extends between a tip 104 and a collar portion represented generally at 106. Collar portion 106 is slideable with the assembly 100 within containment cavity 88. With this arrangement, the extent of motion of the assembly 100 is limited to a very small exptent wherein the pen user is given the physical impression of an ink pen on paper when the pen 50 is positioned as shown in FIG. 5. FIGS. 6 and 7 further reveal that the polymeric/dielectric pen tip 58 is slideably mounted over the necked-down portion 74 of electrostatic shield 72 and is retained at the mouth 60 of outer housing 52 by an outwardly depending integrally formed rearward collar 108 which is freely abuttably contactable with a corresponding annular ledge seen in FIG. 6 at 110 formed within outer housing 52. FIG. 6 further reveals that tip 58 is internally configured having a tip receiving cavity 112 which abuttably receives tip 104 of pick-up rod assembly 100. Cavity 112 additionally functions to align the rod-shaped portion 102 of pick-up rod assembly 100 within necked-down portion 74 of shield 72 (FIG. 7). As seen in FIG. 7, collar assembly 106 of pick-up rod assembly 100 is configured with a rearwardly depending connector portion 114 and a forwardly disposed switching portion represented generally at 116. FIG. 6 reveals that connector portion 114 is coupled by solder to the forward connector portion 118 of a helical spring represented generally 120. Formed, for example, of beryllium-copper, spring 120 functions as a portion of the pen circuit as well as to forwardly bias pick-up rod assembly 100. In this regard, spring 120 extends rearwardly along pen axis 70; is soldered at its rearward or anchor end 122 to a junction 124 carried by an elongate narrow printed circuit board represented generally at 130. Circuit board 130 is mounted in the intermediate region of cartridge enclosure 80 and carries a signal treatment network the input to which is coupled with helical spring 120 at junction 124. Additionally, circuit board 130 supports a pen orientation detector network determining whether pen 50 is in a pen-up or a pen-down interaction orientation. It will be seen to be uniquely carried out utilizing the input bias developed at the buffering signal treatment network. Looking additionally to FIGS. 8 and 9, circuit board 130 is configured having oppositely disposed surfaces designated as an upper surface 132 (FIG. 8) and lower surface designated 134 (FIG. 9). The component extends between a forward end represented generally at 136 and a rearward end represented generally at 138. As seen in FIG. 8, an array of four input/output terminals is located adjacent the rearward end 138 of circuit board 130. As illustrated in FIG. 6, these terminals are soldered with a corresponding array of the four leads carried within cable assembly 64 and shown in general at 142. One of the leads of array 142 carries a ground condition which is distributed at board 130. This ground is distributed, inter alia, to a junction 144 seen in FIG. 9 and located at the underside 134 of printed circuit board 130. FIGS. 6 and 7 reveal a resilient electrical contact 146 which conveys this ground to electrostatic shield 72 at its sleeve portion 76. Engagement is made through a rectangular opening 148 formed within cartridge enclosure component 82. Cartridge enclosure component 84, being identically configured, also is formed with such an opening as seen at 150 in FIG. 7.

FIGS. 6 and 7 further reveal that cartridge enclosure 80 as is represented by components 82 and 84 is configured at its cable engagement region 92 to mechanically surmount the integrally molded engagement components 152 and 154 of cable assembly 64. In this regard, FIG. 7 reveals that cartridge enclosure component 82 is configured with engagement cavities 156 and 158 which surmount one half of respective components 152 and 154, while cartridge enclosure component 84 is configured with engagement cavities 160 and 162 configured to surmount the opposite half of those engagement components. Located rearwardly of engagement cavities 158 and 162 is a seating cavity shown generally at 164 in FIG. 6 which receives and is covered by cap members 166 and 168 of cable assembly 64. FIG. 7 reveals that the cavity 164 is configured from half cylindrical cavity components 170 and 172 formed within respective cartridge enclosure components 82 and 84.

Current pens intended for electrographic performance generally employ a costly and somewhat inefficient switching technique to derive necessary pen-up and pen-down orientation signals. For instance, to close a normally open switch requires a somewhat elaborate scheme as well as a generally physically recognizable mechanical motion for switch closure. With the instant design, a significant number of switch parts are eliminated and the pick-up rod assembly motion required for switch actuation is essentially not noticeable by the user. FIGS. 6A and 6B reveal this improved and simply fabricated pen orientation switching function as represented in general at 180. In FIG. 6A, the switch function 180 is represented in its normally closed orientation. The figure reveals that the switching portion 116 of the collar portion 106 of pick-up rod assembly 100 is configured with a forward facing switch surface 182 against which is located a contact surface 184. Contact surface 184 is provided as a conformable electrically conductive material such as a carbon-filled silicon polymeric material. Looking additionally to FIG. 6C, contact surface 184 is developed by an annular component having a central opening 186 which elastically engages a relief 188 formed within rod component 102 of pick-up rod, assembly 100. Contact surface 184 is axially mechanically biased forwardly by helical spring 120 as it engages connector portion 114 of collar portion 106.

FIG. 6A shows the switching function 180 in its normally closed orientation wherein spring 120 mechanically biases contact surface 184 against the U-shaped contact portion 190 of a transition contact member represented generally at 192. Member 192 extends rearwardly to a resiliently biased rearward contact 194 which engages the pad-like junction 200 located at forward region 136 of printed circuit board 130 as seen in FIG. 9. With the arrangement shown, a tip switch input representing either a pen-up orientation or a pen-down orientation is promulgated from contact 194 to the input of a pen orientation detector network located on circuit board 130 and having an output at terminal array 138. FIG. 6D reveals a perspective view of this resilient transition contact member 192. The normally closed orientation of the switching function 180 seen in FIG. 6A corresponds with a pen-up condition. Utilization of the conformal contact surface as at 184 substantially improves the contact reliability of the switch contact function inasmuch as essentially an infinite number of contact points are established. Additionally, by providing the transition contact member 192 as a stamped metal part switched simplicity is achieved with attendant lower cost. In the closed orientation shown, the contact member 192 conveys a voltage bias developed at the buffering input of the signal treatment network to the pen orientation detector network. No soldering is involved in developing this transition function. Note additionally that the switching function 180 is retained within the earlier-described containment cavity 88. Cavity 88 is configured to restrict the extent of axial motion of the switch function 180 to an open contact orientation. Because the actuation is from a normally closed switching condition to an open switching condition, only a very minor amount of movement is required to develop a pen-down tip switch signal. Accordingly, the cavity 88 is configured to permit as small a switch gap as possible to achieve a pen performance that appears to have virtually no movement that is detectable by the user. It is to be contrasted with much more movement being required to close the contacts of a normally pen switching function.

FIG. 6B reveals the orientation of the components of switching function 180 as this pen-down configuration is developed. The tip switch signal representing an open switch condition appears as soon as contact surface 184 moves from contact portion 190 of transition contact number 192.

Referring to FIG. 10 the circuitry generally supported from printed circuit board 130 is revealed in schematic fashion. In general, this circuitry includes a signal treatment network represented generally at 210 and a pen orientation detector network represented generally at 212. Network 210 is seen addressed by earlier-described junction 124 which, as represented by arrow 214 is electrically connected to the anchoring end of spring 120. Pick-up assembly 100 is schematically represented in conjunction with a spring bias normally closed switching function 180 with schematic terminals 216 and 218. Terminal array 140 reappears in block schematic form and is seen to provide a distributed ground as represented at line 220. A pen position signal representing the earlier-described coordinate pairs is outputted at line 222. A +5 volt source (VCC) is inputted and distributed as represented at line 224; and tip switch related outputs are provided at line 226 to identify a pen-up or a pen-down orientation.

Now looking to signal treatment network 210, the network is seen to incorporate an operational amplifier functioning as a buffer amplifier 230. Amplifier 230 is coupled to ground via line 232 and to +5V (VCC) as represented at line 234. Inasmuch as a single voltage source at +5V is present, it is necessary to bias amplifier 230, for instance, at somewhere without range of 2-3.5 volts to permit a.c. amplification. For this purpose, +5V d.c. (VCC) at line 236 is divided down with resistors R1 and R2 which, for example, may be 10 k ohms. This provides the 2-3.5 volt d.c. bias, such range permitting a.c. amplification without saturation. A typical output from the pick-up assembly 100 will be on the order of 100 to 200 millivolts, thus a relatively large range is available for buffering amplification. It may be observed that resistor R2 is within a line 238 extending between ground at line 236 and is coupled in parallel with a capacitor C1 which makes the node established with resistors R1 and R2 an a.c. ground. Accordingly, from an a.c. perspective the node is ground and from a d.c. perspective it is sitting at bias voltage. The two inputs to the amplifier 230 are coupled to that same node. Note that lines 240 and 242 extend to the negative terminal of amplifier 230. Line 242 bisects line 240 containing resistor R3 and line 222 containing resistor R4. Resistors R3 and R4 set the gain for amplifier 230 which provides an output at line 244 extending to terminal array line 222. The opposite input to amplifier 230 is at line 246 extending from junction 124 and incorporating input resistor R5. Bias is fed to line 246 via line 248 incorporating resistor R6. The bias at line 246 will be present in the circuit as it extends to pick-up rod assembly 100 and for a normally closed switch orientation as shown will be conveyed via transition contact number 192 as represented at arrow 250 to junction 200 at the input of pen orientation detector network 212. Because a switching takes place with respect to developed switching signals, the input at junction 200 is directed as represented at line 252 to line 254 intermediate very large resistors (20 Megohms) R7 and R8. Accordingly, these resistors present a high non-disturbing resistance to amplifier 230. Line 254 extends to a high impedance buffer herein represented as an NPN transistor Q1, the collector of which is coupled with +5V (VCC) via line 256 and the emitter of which extends as represented at line 258 through resistor R9 to ground. Components other than a transistor can be implemented for this high impedance buffering and function. The emitter of transistor Q1 as it extends from line 258 to line 260 provides an input to the gate of a field effect transistor (FET) Q2. The drain of transistor Q2 is coupled via line 262 and resistor R10 to +5V (VCC), while its source is coupled to ground through line 264. Drain line 262 of FET Q2 is coupled via tip switch output line 226 incorporating resistor R11 to the cable assembly 64.

With the arrangement shown, for a pen-up orientation wherein switch function 180 is closed the protected bias at amplifier 230 is conveyed to the base of transistor Q1 to turn it on turning transistor Q2 on and the tip switch output at line 226 is represented as a ground condition or logic low.

On the other hand, when the switching function 180 reverts from a normally closed condition to an open condition, a pen-down orientation is present and the bias asserted at junction 200 is removed to turn transistor Q1 off. Consequently, transistor Q2 turns off and lines 262 and 226 exhibits a logic high tip switch signal representing pen-down. Note that a timing capacitor C2 is incorporated within line 266 between line 268 and ground. This component in conjunction with resistor R9 functions to provide a universal accommodation of polluted coordinate data evolved in the course of pen movement into contact with the electrostatic surface where the voltage collected at the pen tip is used to determine position on the tablet. The voltage change on the pen tip must be due to the position change on the tablet as opposed to the height change off of the tablet. In FIG. 11, the vertical or 3-axis orientation of the pen tip is represented generally at curve 270 which is aligned with a timeline represented generally at 272 with arbitrary time components t₁-t₈ associated with pen-up maneuvers toward a pen-down position; a pen-down position; and a subsequent pen-up position. These positions are represented respectively at curve components 273-275. Note in this regard that curve component 273 represents the maneuvering of the pen tip towards the electrostatic surface over a period extending from time t₁ to t₄. At time t₄, the pen tip is assumed to be down and in contact with the glass support. This pen-down orientation represented at curve component 274 extends from time t₄ to t₇. As the pen is then picked up, as represented at curve component 275, time component t₇ and t₈ are redefined.

Now looking to FIG. 12, a tablet glass support is represented at 278 under which a patterned electrographic surface such as indium-tin oxide is located at represented at 280. The borders of the tablet are coupled between an a.c. source and ground as represented respectively at lines 282 and 284. Those borders are switched as above described, four measurements being required by excitation at different borders of the tablet. Such coordinate readouts are spaced apart in time as the pen tip approaches the glass surface 278. At times t₁-t₄ vertical or z-axis pen tip distance above the surface of glass support 278 will vary with tip or pen orientations as seen at 290-292. Switch function 180 will be in a normally closed orientation during this progression toward the surface of the glass and a capacitive coupling with electrostatic surface 280 will vary but will not represent x-y position but height. Inasmuch as the receiving system generally will not recognize this condition, it will attempt to create coordinate pair data which is invalid or polluted. Capacitance will be a function of not only the dielectric attribute of the glass surface 270 but also the air gap from the pen tip as well as the polymeric pen tip 58. At pen-down position 293 with the opening of switch function 180 the capacitance now is fixed and is represented by the dielectric aspects of the pen tip 52 and glass 278. This capacitance attribute now is constant as represented at curve portion 274 in FIG. 11 and in conjunction with pen orientations 293 through 296 the coupling capacitance is constant throughout the time range from t₄ through t₇. Voltage readouts during that pen-down intervals will be accurate. At time t₇ and pen orientation 296 the operator lifts the pen to a pen-up orientation; and switch function 180 closes for the curve component 275. The pen tip orientation as represented at 297 is above the surface of glass support 278 and switch function 180 is normally closed.

It is desirable to accommodate for such height or z-axis coordinate pollution universally for all devices which may be in the field. In effect, it is desirable that the pen 50 be backwards compatible with essentially all forms of electrographic devices. Where systems are marketed with pen and tablet together along with control features, then the solution to this data pollution phenomena can be accommodated for in firmware. However, to provide a universally compatible pen, a delay is imposed commencing with pen-down position 293 and the opening of switch function 180. That delay is derived from an RC network represented generally at 300 in FIG. 10, comprised of capacitor C2 and resistor R9. This delay is generally not noticeable inasmuch as the sampling rate is on the order of about 1-5 milliseconds. At the transition to a pen-up orientation, for example, at time t₇ shown at FIG. 11, it is desirable to send the tip switch signal or condition as quickly as possible into the system to avoid a new set of polluted or inaccurate coordinate signals. Thus network 300 is delayed during a transition to a down position and is quite fast in a transition from a pen-down position to a pen-up position.

Accordingly, where switch 180 is closed and the pen is transitioning from a pen-up condition toward time t₄, transistor Q1 is on and capacitor C2 is very, very rapidly charged. However, with the pen-down orientation 293 at time t₄, switching function 180 is opened, buffer transistor Q2 is turned off and capacitor C2 discharges through resistor R8. During this interval of delay, transistor Q2 is on and the tip switch condition at line 226 is at a pen-up ground or logic low. Upon the discharge of capacitor C2, transistor Q2 is turned off and a logic high pen-down tip signal condition is asserted at line 226. A subsequent pen-up orientation as represented in FIG. 11 at time t₇ results in the turning on of transistor Q1 and the very rapid charging of capacitor C2 providing for the essential absence of a delay interval.

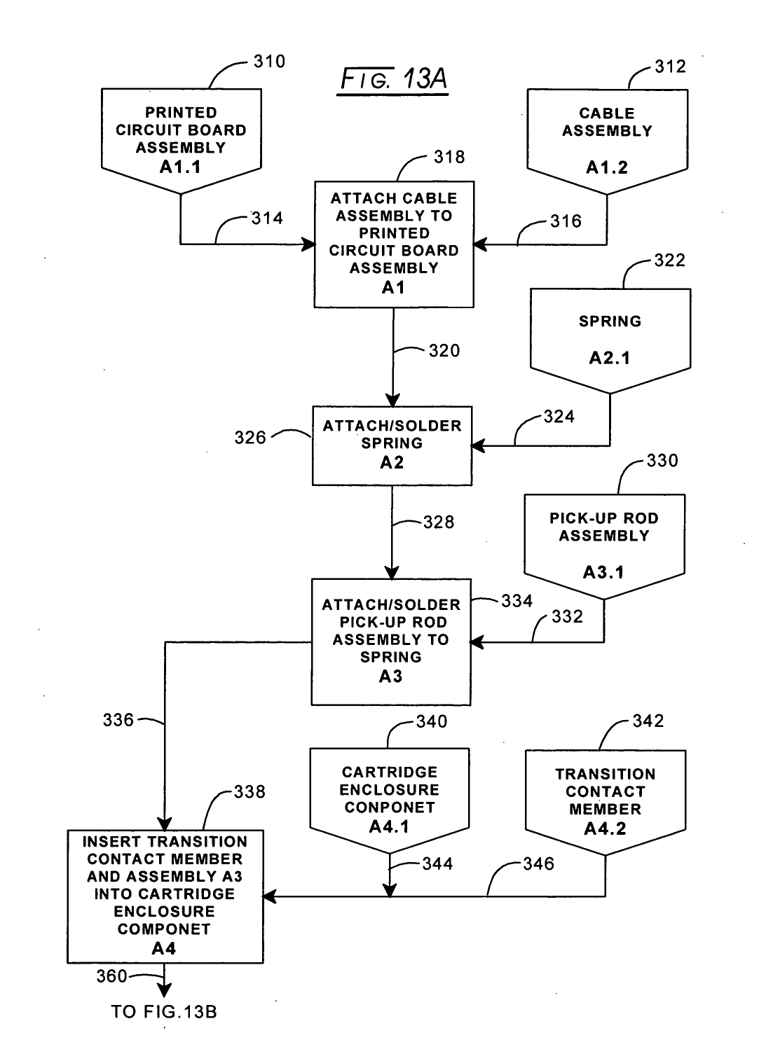

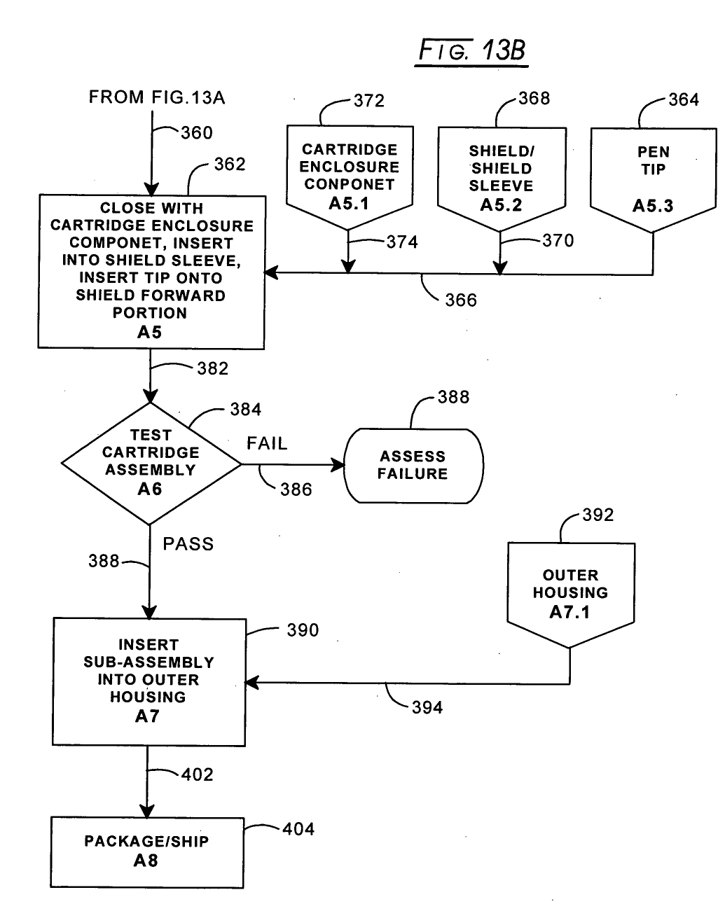

The assembly of pen 50 is carried out utilizing a minimum number of parts as well as joint soldering procedures and switching function 180 with its quite simple stamp metal transition contact member evokes reliability and lower cost. As another aspect of this advantageous simplicity, the assembly of the pen is carried on in what may be termed an axial fashion. The assembly procedure is outlined in connection with FIGS. 13A and 13B which should be considered together as labeled thereon. In the figures, those blocks having a triangular lower border are considered to be parts or components while the rectangular blocks are descriptive of the assembly operation associated with parts or the like. Referring to FIG. 13A, a printed circuit board assembly as at 130 which is combined with grounding contact 146 is provided as represented at block 310. Additionally, a cable assembly as at 64 is provided as represented at block 312. These components additionally are respectively identified as A1.1 and A1.2. As represented at arrows 314, 316 and operation A1 block 318, the cable assembly is attached to the printed circuit board assembly, the four leads of lead array 142 (FIG. 6) being soldered to terminal array 140 (FIG. 8). The procedure then continues as represented at arrow 320 and block 322. At block 322 the helical spring 120 (FIG. 7) is provided as a component A2.1 and is available as represented at arrow 324 to the operation at block 326 and identified as A2. This procedure provides for the attachment and soldering of spring 120 at its rearward or anchor end 122 to junction 124 (FIG. 9) of printed circuit board 130. The spring is symmetrically aligned about the pen axis 70 (FIG. 6).

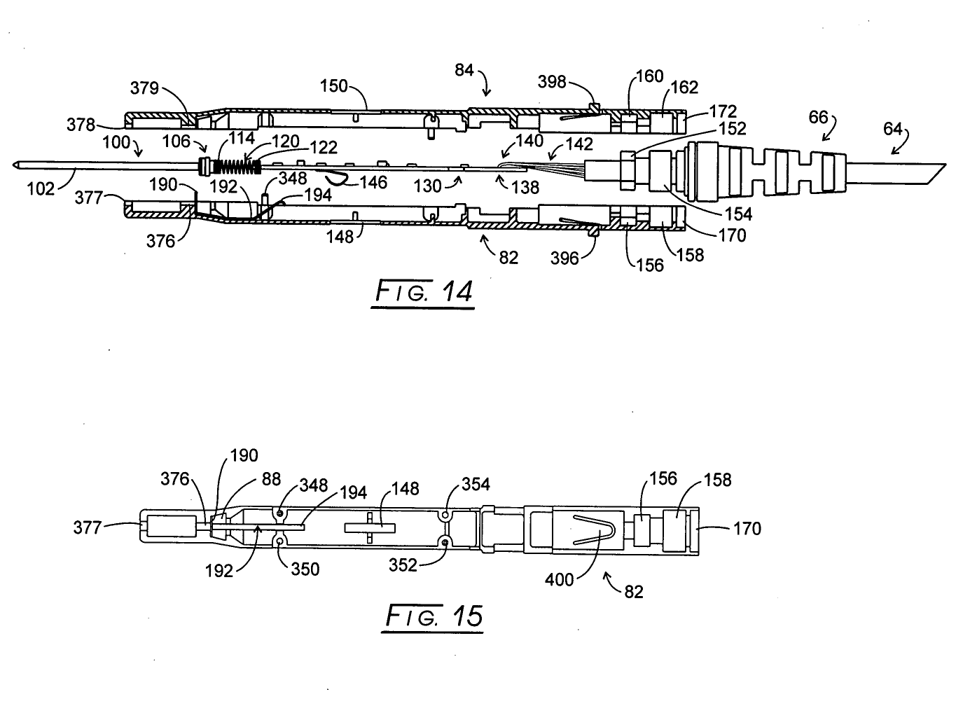

Looking momentarily to FIG. 14, the assembly thus far developed is seen to include the cable assembly 64 and its lead array 142 which is coupled to the array of terminals 140 upon the upward side of the rearward portion 138 of circuit board 130. The anchor or rearward end of spring 120 has now been connected to be aligned with the pen axis and soldered to junction 124 as described in connection with FIG. 9.

Returning to FIG. 13A, as represented at arrow 328, the procedure looks to the pick-up rod assembly identified as component A3.1 and shown in block 330. As represented at arrow 332 and block 334, the connector portion 114 of collar portion 106 of the pick-up rod assembly 100 is soldered to the forward end of spring 120. This procedure is identified as A3 and, as seen in FIG. 14, the pick-up rod assembly is seen to be connected for alignment with the pen axis as is the spring 120, circuit board 130, and the lead array 142. This defines a sub-assembly locatable about the pen axis. Next, as represented at arrow 336, the procedure continues to block 338 providing for the insertion of the transition contact member 190 as well as the sub-assembly A3 into one cartridge enclosure component. In this regard, a cartridge enclosure component is made available as represented at block 340, as identified at A4.1 and a transition contact member is made available and represented at block 342 identified as component A4.2. The delivery of the components is represented by arrows 344 and 346. Looking momentarily to FIG. 15, transition contact member 192 is seen to be positioned upon an upwardly facing cartridge enclosure 82 in a manner wherein U-shaped contact portion 190 is upwardly oriented and within one half of the containment cavity 88. Note that the resilient contact component 194 is retained in axial alignment by two bolsters, one of which is configured with an integrally formed alignment pin 348. The opposite bolster is shown at 350 and is seen to be configured with an integrally formed alignment hole. Spaced rearwardly from alignment pin 348 and alignment hole 350 are corresponding integrally formed alignment pin 352 and alignment hole 354. As noted above, cartridge enclosure component 84 is identically structured. FIGS. 8 and 9 reveal that printed circuit board 130 is configured with four alignment through-holes 356-359. These alignment through-holes 356-359 are located to receive the alignment pins as at 348 and 352 shown in FIG. 15 as well as the corresponding alignment pins of cartridge enclosure component 84.

Returning to FIG. 13A, looking to arrow 360 which reappears in FIG. 13B, as represented at block 362, procedure A5 is carried out in conjunction with pen tip 58 as represented at block 362, component A5.3 and arrow 364; shield 52 as represented at block 366 and arrow 368 identified as A5.2; and cartridge enclosure component 84 as represented at block 370, identified as component A5.1 and is associated with arrow 372. Returning to FIGS. 14 and 15, the rod component 102 of pick-up assembly 100 is slideably mounted upon grooves 374 and 376 which are upwardly facing in cartridge enclosure component 82. In similar fashion, grooves 378 and 380 (FIG. 14) are positioned over the rod portion 102 to provide a confined slideable engagement. With the definition of the cartridge enclosure the sleeve portion of electrostatic shield 72 (FIG. 7) is positioned over the forward portion of the cartridge enclosure to secure those members together and tip 58 is positioned over the neck-down portion 74 of the shield 72. The pen tip 58 functions to engage the tip 104 of the pick-up rod assembly and align it within the necked-down portion 74 of electrostatic shield 72. Next, as represented at arrow 382 and block 384, as a procedure A6, the assembled cartridge assembly with shield and tip is tested. In the event of a failure of such test, as represented at arrow 386 and block 388, the test failure is assessed. Where the test is passed, then as represented at arrow 388 and block 390 as a procedure A7, the sub-assembly thus far developed is slideably inserted into the outer housing 52. In this regard, as represented at block 392 and arrow 394, the outer housing is provided as a component A7.1. Returning momentarily to FIGS. 14 and 15, each of the cartridge enclosure components 82 and 84 are configured with integrally molded detent dogs or connectors shown respectively at 396 and 398. Dogs 396 and 398 are configured to flex inwardly by virtue of an integrally molded spring portion, one of which is seen at 400 in FIG. 15. As the procedure A7 at block 390 is carried out, these dogs 396 and 398 will resiliently engage holes in the outer housing 52, one of which has been identified at 68 in FIGS. 5 and 7.

Finally, as represented at arrow 402 and block 404, identified as procedure A8, the completed pen is packaged and shipped.

Since certain changes may be made in the above-described apparatus and method without departing from the scope of the invention herein involved, it is intended that all matter contained in the description thereof or shown in the accompanying drawings shall be interpreted as illustrative and not in a limiting sense.

1. Pen apparatus for collecting position signals from an electrographic surface, comprising:
an outer housing generally extending along a pen axis from a tip region to a cable support region;
a pick-up rod assembly within said outer housing slideably disposed along said pen axis, having a tip located at said housing tip region interactable with said surface and having an actuator assembly mounted to provide a switching movement;
a spring within said outer housing having a forward end coupled with said actuator assembly in forward spring biasing relationship therewith, and extending along said pen axis to an anchoring end;
a signal treatment network within said outer housing having an input exhibiting a bias voltage electrically coupled with said pick-up rod assembly and having a pen position signal output at said cable support region;
a pen orientation detector network within said outer housing responsive to the presence or absence of an applied said bias voltage to provide outputs at said cable support region corresponding with the pen-down interaction or pen-up non-interaction of said pick-up rod assembly with said electrographic surface; and
a switch assembly responsive to said actuator assembly switching movement to establish said presence or absence of said bias voltage at said pen orientation detector network.

2. The pen apparatus of claim 1 further comprising:
a cartridge enclosure mounted within said outer housing extending between said tip region and said cable support region, configured to support said pick-up rod assembly, defining the extent of switching movement of said actuator assembly, and further configured to support said signal treatment and said pen orientation detector networks.

3. The pen apparatus of claim 1 in which:
said spring is electrically conductive and is supported within said cartridge enclosure at said anchoring end from connection with said signal treatment network.

4. The pen apparatus of claim 2 further comprising:
an electrostatic shield mounted within said outer housing, extending over at least that portion of said cartridge enclosure supporting said signal treatment and pen orientation detector networks, said spring, said switch assembly and is configured with a necked-down portion extending from said cartridge enclosure at said tip region to shield a substantial portion of said pick-up rod assembly.

5. The pen apparatus of claim 4 further comprising:
a polymeric, electrically insulative pen tip slideably mounted upon said electrostatic shield at said necked-down portion, engaged with said pick-up rod assembly tip and moveable therewith to define said pen-down interaction or pen-up non-interaction with said electrographic surface.

6. The pen apparatus of claim 1 in which said pen orientation detector network comprises:
a solid state input buffer network responsive to the assertion or non-assertion thereto of said bias voltage to derive a buffer condition; and
a solid state detector switching network responsive to said buffer condition to derive a said output at said cable support region corresponding with said pen-down interaction or pen-up non-interaction of said pick-up assembly with said electrographic surface.

7. The pen apparatus of claim 6 in which said pen orientation detector network further comprises:
a delay network responsive to a buffer condition corresponding with a pen-down interaction to impose a delay in said response of said detector switching network.

8. The pen apparatus of claim 7 in which:
said delay network is substantially non-responsive to a buffer condition corresponding with a pen-up non-interaction of said pick-up rod assembly with said electrographic surface.

9. Pen apparatus for collecting position signals from an electrographic surface, comprising:
an outer housing generally extending along a pen axis from a tip region to a cable support region;
a pick-up rod assembly within said housing slideably mounted along said pen axis, having a tip located at said housing tip region, interactable with said surface, having a pen-down orientation when in contacting adjacency with said surface and a pen-up orientation when spaced from said surface having an actuator assembly with a switching portion having a connector portion and being mounted to define an extent of switching movement;
a spring within said housing having a forward end coupled with said actuator assembly connector portion and mechanically biasing it forwardly to normally provide said pen-up orientation;
a signal treatment network within said outer housing having an input electrically coupled with said pick-up rod assembly and having a pen position signal output at said cable support region;
a pen orientation detector network within said outer housing responsive to a tip switch input to provide detector outputs corresponding with said pen-down and pen-up orientations; and
a transition contact member configured with a contact portion to define a switch with said actuator assembly switching portion deriving said tip switch input.

10. The pen apparatus of claim 9 in which:
said transition contact member contact portion is located forwardly of said actuator assembly switching portion to define a normally closed switch configuration under the mechanical bias of said spring.

11. The pen apparatus of claim 10 in which:
said normally closed switch configuration corresponds with a pen-up orientation, and said pen-down orientation is derived by moving said actuator assembly switching portion rearwardly against the mechanical bias of said spring to define an open switch.

12. The pen apparatus of claim 9 in which:
said actuator assembly switching portion is configured with a contact surface formed of a conformable electrically conductive material.

13. The pen apparatus of claim 12 in which:
said electrically conductive material is a carbon-filled silicon polymeric material.

14. The pen apparatus of claim 9 further comprising:
a cartridge enclosure mounted within said outer housing, extending between said tip region and said cable support region, configured to slideably support said pick-up rod assembly, having a switch containment cavity receiving said actuator assembly switching portion and defining said extent of switching movement, and further configured to support said signal treatment and said pen orientation detector networks.

15. The pen apparatus of claim 14 further comprising:
an electrostatic shield mounted within said outer housing, extending over at least that portion of said cartridge enclosure supporting said signal treatment and pen orientation detector networks, said spring, said switch and is configured with a necked-down portion extending from said cartridge enclosure at said tip region to shield a substantial portion of said pick-up rod assembly.

16. The pen apparatus of claim 15 further comprising:
a polymeric, electrically insulative pen tip slideably mounted upon said electrostatic shield at said necked-down portion, engaged with said pick-up rod assembly tip and moveable therewith to define said pen-up and pen-down orientations.

17. Pen apparatus for collecting position signals from an electrographic surface, comprising:
an outer generally cylindrical polymeric outer housing extending along a pen axis from a tip region having a mouth to a cable support region;
a generally cylindrical polymeric cartridge enclosure slideably insertable within said outer housing from said cable support region, having a forward region with a containment cavity, an intermediate region, and a rearward, cable engagement region;
a generally cylindrical electrostatic shield having a sleeve portion slideably insertable over said cartridge enclosure, extending at least over said forward region, containment cavity and intermediate region and configured with a necked-down portion extending from said cartridge enclosure forward region to adjacency with said outer housing mouth;
a pick-up rod assembly having a tip outwardly adjacent said mouth, extending rearwardly through said shield necked-down portion to slideable engagement with said cartridge enclosure forward region and having an actuator assembly located at said containment cavity limiting the slideable movement of said pick-up rod assembly;
an elongate printed circuit board mechanically engaged with said cartridge enclosure generally at said intermediate region, having oppositely disposed surfaces extending from a forward edge spaced from said containment cavity to a rearward edge adjacent said cable engagement region;
a signal treatment network mounted upon said circuit board, having an input adjacent said forward edge and an output electrically coupled with a terminal array adjacent said rearward edge;
a pen orientation detector network mounted upon said circuit board, having an input generally adjacent said forward edge and an output electrically coupled with said terminal assembly;
an electrically conductive helical spring fixed to and extending axially forwardly from said circuit board adjacent said forward edge providing electrical communication with said signal treatment network input and in mechanical forward biasing and electrical communication with said pick-up rod assembly connector portion; and
a multi-lead cable assembly mechanically engaged with said cartridge enclosure at said cable engagement region and having leads electrically coupled with said terminal array.

18. The pen apparatus of claim 17 further comprising:
a polymeric, electrically insulative pen tip slideably mounted upon said electrostatic shield at said necked-down portion, extending from said outer housing mouth, abuttably engaged and moveable with said pick-up rod assembly tip.

19. The pen apparatus of claim 18 in which:
said pen tip is configured to align said pick-up assembly as it extends within said electrostatic shield necked-down portion.

20. The pen apparatus of claim 17 in which:
said pick-up rod assembly actuator assembly is configured with a switching portion; and
further comprising a transition contact member with a contact portion engageable with said switching portion to define a closed switch and having an integrally formed resilient extension abuttably contacting said cartridge enclosure at said intermediate region and resiliently biased into abutting electrical contact with a pad configured input to said pen orientation detector network at a surface of said printed circuit board.

21. The pen apparatus of claim 20 in which:
said transition contact member contact portion is located within said containment cavity forwardly of said pick-up rod switching portion to provide a normally closed switch configuration corresponding with a pen-up orientation of said pick-up rod assembly.

22. The pen apparatus of claim 20 in which:
said pick-up rod assembly actuator assembly switching portion is configured with a contact surface formed of a conformal electrically conductive material.

23. The pen apparatus of claim 17 in which:
said polymeric cartridge enclosure is configured with two identical half-members each having one or more outwardly depending alignment pins and correspond alignment pin holes and are joined in freely abutting adjacency; and
said printed circuit board is configured with two or more mounting through-holes located to receive said alignment pins.

24. The method for making a pen apparatus for collecting position signals from an electrographic surface, comprising the steps:
(a) providing a generally cylindrical polymeric outer housing extending, along a pen axis, from a tip region having a mouth, to a cable support region;
(b) providing a pair of generally half cylindrical polymeric cartridge enclosure components which when abuttably mated to define a cartridge enclosure are slideably insertable within said outer housing in symmetrical disposition about said pen axis and define a forward region with a containment cavity, an intermediate region and rearward cable engagement region;
(c) providing an elongate circuit board having oppositely disposed surfaces designated upper surface and lower surface extending between a forward end and a rearward end, said upper surface supporting a signal treatment network having an input junction at said forward end locatable at said, pen axis and an output extending to a terminal array adjacent said rearward end, said upper surface further supporting a pen orientation network having an input at an electrical contact pad generally adjacent said forward end at said lower surface locatable at said pen axis and having an output extending to said terminal array;
(d) providing a pick-up rod assembly extending from a tip to an actuator assembly with a rearward connector portion and forwardly disposed switch contact portion locatable at said cartridge enclosure containment cavity;
(e) providing a cable assembly with an array of leads corresponding with said terminal array;
(e) electrically coupling said cable assembly array of leads with said circuit board terminal array;
(g) providing an electrically conductive helical spring;
(h) coupling said helical spring to said circuit board supported signal treatment network input junction at said forward end in a manner wherein the spring extends forwardly for general alignability with said pen axis to a forward connection portion;
(i) coupling said pick-up rod assembly rearward connector portion to said spring forward connection portion in a manner wherein the pick-up rod assembly extends forwardly for general alignability with said pen axis, said pick-up rod assembly, spring, circuit board and cable assembly defining a sub-assembly generally locatable about said pen axis;
(j) providing a transition contact member with a contact portion and an integrally formed resilient extension;
(k) inserting the transition contact member within one cartridge enclosure component in a manner wherein said contact portion is locatable within said containment cavity and said resilient extension extends rearwardly;
(l) inserting said sub-assembly upon said one cartridge enclosure component;
(m) positioning the other cartridge component over the one cartridge component to define said cartridge enclosure;
(n) providing a generally cylindrical electrostatic shield assembly having a sleeve portion and a forwardly extensible necked-down portion;
(o) inserting the cartridge enclosure within said shield assembly sleeve portion;
(p) providing a polymeric pen tip;
(q) inserting the pen tip over the shield assembly necked-down portion in a manner internally engaging the pick-up rod assembly tip to define a pen interior;
(r) testing the pen interior; and
(s) when the pen interior passes the testing step, then inserting the pen interior into the outer housing.

25. The method of claim 24 in which:
step (b) provides said pair of polymeric cartridge components as being identically configured.

26. The method of claim 24 in which:
step (b) provides a polymeric cartridge component as having at least one shield ground receiving opening located at said intermediate region;
step (c) provides said circuit board as having a resilient downwardly depending shield ground contact at said lower surface and located to be moveable through a said ground receiving opening during step (l); and
step (o) effects the electrical contact of said shield ground contact with the interior of said shield assembly sleeve portion.

27. The method of claim 25 in which:
step (b) provides each cartridge enclosure component intermediate region with two or more integrally formed alignment pins and corresponding oppositely disposed alignment holes;
step (c) provides the circuit board as having four or more alignment through-holes located for engagement with said alignment pins; and
step (l) effects the engagement of said through-holes with said alignment pins.

28. The method of claim 27 in which:
step (m) effects the insertion of said alignment pins into said alignment holes subsequent to step (l).
